(19) United States
(12) Patent Application Publication
(10) Pub. No.: US 2026/0063186 A1
(43) Pub. Date: Mar. 5, 2026

(54) HEAD EXTENSION FOR SURFACE TREATMENT OPERATIONS

(71) Applicant: James D. Partridge, Alabaster, AL (US)

(72) Inventor: James D. Partridge, Alabaster, AL (US)

(21) Appl. No.: 19/319,551

(22) Filed: Sep. 4, 2025

Related U.S. Application Data
(60) Provisional application No. 63/690,714, filed on Sep. 4, 2024.

(51) Int. Cl. F16H 25/14; B08B 3/02; B24C 9/00; F16H 57/02; F16H 57/031

(52) U.S. Cl. CPC F16H 25/14; F16H 57/031; B08B 3/02; B24C 9/00; F16H 2057/02034; F16H 2057/02069

(57) ABSTRACT

Head extension for surface treatment operations including housing with first operative end and second operative end, both ends being open. Head extension incorporates cam assembly and holder assembly within housing. Cam assembly comprises motor, shaft, and plurality of cams configured to facilitate linear reciprocating movement. Holder assembly includes plurality of support plates and support loops configured to hold hoses used in surface treatment operations. Hoses extend through housing and interact with cams to achieve linear reciprocating movement. Head extension is designed for mounting on portable lifting equipment, such as portable crane or aerial work platform, thus allowing human operator to perform surface treatments at elevated or hard-to-reach locations while remaining on ground. Head extension is adaptable for use with various types of surface treatment media, including abrasives, water jets, and chemical sprays, providing versatility and enhancing operational efficiency and safety.

### BACKGROUND OF THE INVENTION

The present application claims the benefit of U.S. Provisional Application No. 63/690,714, filed Sep. 4, 2024; all of which is incorporated herein and referenced thereto.

### FIELD OF THE INVENTION

The present invention relates to surface treatment equipment, and in particular, relates to a head extension for surface treatment operations, such as sandblasting, pressure washing, cleaning, and painting, incorporating cam-operated mechanisms to maneuver various tools and provide enhanced precision and versatility for industrial and commercial applications.

### DESCRIPTION OF THE PRIOR ART

Surface treatment systems are widely used in various industries for cleaning, preparing, and coating surfaces. These systems typically involve the use of sandblasting, pressure washing, or similar processes to treat surfaces effectively. Traditional systems often consist of fixed or semi-automated equipment where nozzles or heads direct treatment media towards the surface being treated. While effective, these systems can be limited in their flexibility and adaptability to different surface geometries, mounting platforms, and operational environments.

Several prior art references disclose surface treatment systems with specific functionalities. One example is U.S. Pat. No. 8,864,240 B2, entitled “Vertical or Horizontal Robot for Hydrodemolition of Concrete” (“the '240 Patent”). The '240 Patent describes a robotic system designed for the hydrodemolition of concrete surfaces on large structures, such as dams. The system includes a boom with a cutting nozzle that can be oriented either vertically or horizontally, depending on the configuration. The boom is mounted on a hydraulic elevating platform that can climb or move along a tower, allowing the robot to treat concrete surfaces with high-pressure water jets. Although this system offers versatility in terms of orientation and movement, it is primarily focused on hydrodemolition and lacks the capability to easily integrate with other surface treatment tools or adapt to various surface treatment operations beyond concrete demolition.

Another example is U.S. Pat. No. 11,370,085 B2, entitled “Shot Treatment Apparatus and Shot Treatment Method” (“the '085 Patent”). The '085 Patent describes a shot treatment apparatus designed for mass production of a wide range of products. The system features a spinning table that holds and rotates a workpiece while a nozzle ejects shot media towards it. The nozzle is positionable and three-dimensionally swingable, allowing for precise targeting during the treatment process. The system also includes a revolving table that moves multiple spinning tables through various treatment chambers, enhancing processing efficiency. Despite its advanced control mechanisms and ability to handle various workpieces, this system is primarily focused on fixed setups and lacks the adaptability to different mounting platforms or integration with other surface treatment tools.

Yet another example is U.S. patent application No. 20200147756A1, titled “Mobile Blasting Apparatus” (“the '756 Application”). This application discloses a mobile blasting apparatus designed to automate the surface treatment of large-scale products, such as wind towers and storage vessels. The apparatus includes a main body mounted on a frame structure with a rail system, enabling the device to move along a predetermined path. A key feature is the spraying device, which is capable of ejecting abrasive materials onto the surface of the workpiece. This apparatus reduces manual labor, thereby minimizing worker exposure to harmful dust and the physical demands associated with traditional blasting methods. However, the device is focused primarily on linear movement along a fixed path and lacks versatility in adapting to non-linear, complex surface geometries or multiple work environments.

Although the above-discussed disclosures are beneficial, they have certain limitations. Traditional systems are often designed for specific tasks, with limited adaptability for different environments or surface geometries. These systems may also lack the capability to integrate multiple treatment tools into a single, versatile attachment.

Therefore, there is a need in the art for a head extension that enhances the flexibility and versatility of surface treatment operations, allowing it to be mounted on various platforms and used with different tools for multiple surface treatment tasks.

### SUMMARY OF THE INVENTION

It is an object of the present invention to provide head extension for surface treatment operations that enables efficient and effective treatment of surfaces located at elevated or hard-to-reach areas without need for ladders or lifts.

It is another object of the present invention to provide head extension adaptable to various surface treatment operations, such as sandblasting, painting, pressure washing, and chemical spraying, enhancing versatility and applicability of the extension in different industrial contexts.

In order to achieve one or more objects, the present subject matter provides head extension configured for surface treatment operations. Head extension includes housing with first operative end and second operative end, both of which are open. Housing comprises base and pair of sidewalls extending substantially vertically from lateral ends of base. Adjacent to first operative end, housing includes cam assembly. Cam assembly includes motor affixed to exterior surface of one sidewall of housing, shaft supported on mount bearings and coupled to motor, and plurality of cams provided on shaft in spaced-apart manner.

Head extension also includes holder assembly configured adjacent to second operative end of housing. Holder assembly includes plurality of support plates positioned across width of housing and supported on pair of sidewalls near second operative end. In one embodiment, support plates are positioned in spaced-apart manner and affixed to sidewalls. In another embodiment, support plates may be removably connected to sidewalls through press-fit or snap-fit arrangements, allowing for easy replacement or reconfiguration.

Each support plate further includes at least one support loop extending into interior space of housing. Support loops hold hoses used in surface treatment operations. Hoses extend out from first operative end of housing, interacting with cams. Rotation of cams, driven by motor, facilitates linear reciprocating movement necessary for effective surface treatment.

In one aspect of the present subject matter, hoses can be any type of hoses used in surface treatment operations, such as those for sandblasting, painting, or pressure washing. Versatility of head extension allows for adaptability to various surface treatment needs, ensuring broad applicability in different environments and conditions.

In another aspect of the present subject matter, head extension is designed to be mounted on portable lifting equipment, such as portable crane, aerial work platform, scissor lift, or telescopic boom. Such configuration enables human operator to perform surface treatment tasks at elevated locations while remaining safely positioned on ground, thereby reducing risks associated with working at heights.

In yet another aspect of the present subject matter, head extension can incorporate automated control systems, such as sensors and actuators, to further enhance efficiency and safety. Such systems may be configured to detect position of head extension and automatically adjust movement of hoses based on surface being treated. Such automation reduces need for manual intervention and improves overall operational safety.

One advantageous feature of the present subject matter is that linear reciprocating movement of hoses facilitates extensive coverage of surface area with minimal repositioning of head extension. This reduces physical effort required by human operator and minimizes downtime associated with repositioning equipment, thereby enhancing efficiency of surface treatment process.

Another advantageous feature is adaptability of head extension to various surface treatment media and methods. Head extension can be used with different types of treatment media, such as abrasives, water jets, or chemical sprays, thus making it suitable for wide range of industrial applications.

Another advantageous feature of the present subject matter is inclusion of cam assembly that provides automated reciprocating movement to hoses, eliminating need for human operator to manually move dispensing hoses.

In yet another advantageous feature, head extension may be designed with different materials or configurations to suit specific environmental conditions or operational requirements, such as high-temperature resistance or corrosion resistance.

These and other objects of the present invention will be apparent from the review of the following specification and the accompanying drawings.

### BRIEF DESCRIPTION OF THE DRAWINGS

FIG. 1 is a perspective view of a head extension for surface treatment operations, in accordance with one exemplary embodiment of the present subject matter.

FIG. 2 is a is another perspective view of a head extension for surface treatment operations, in accordance with one exemplary embodiment of the present subject matter.

FIG. 3 is yet another perspective view of a head extension for surface treatment operations depicting hoses used in sand blasting operation, in accordance with one exemplary embodiment of the present subject matter.

FIG. 4 is an exploded view of a head extension for surface treatment operations, in accordance with one exemplary embodiment of the present subject matter.

FIG. 5 is an environment in which the head extension for surface treatment operations implements, in accordance with one exemplary embodiment of the present subject matter.

FIG. 6 is a view of a full assembly for sandblasting including a head extension for surface treatment operations, in accordance with one exemplary embodiment of the present subject matter.

FIG. 7 is another perspective view of a head extension for surface treatment operations, in accordance with one exemplary embodiment of the present subject matter.

FIG. 8 is a cutaway view of a head extension for surface treatment operations, in accordance with one exemplary embodiment of the present subject matter.

FIG. 9 is another cutaway view of a head extension for surface treatment operations, in accordance with one exemplary embodiment of the present subject matter.

FIG. 10 is another perspective view of a head extension for surface treatment operations, in accordance with one exemplary embodiment of the present subject matter.

FIG. 11 is a front view of a head extension for surface treatment operations, in accordance with one exemplary embodiment of the present subject matter.

FIG. 12 is a top view of a head extension for surface treatment operations, in accordance with one exemplary embodiment of the present subject matter.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed mat. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed mat.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes a mat, it is to be further understood that numerous changes may arise in the details of the embodiments of the mat. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

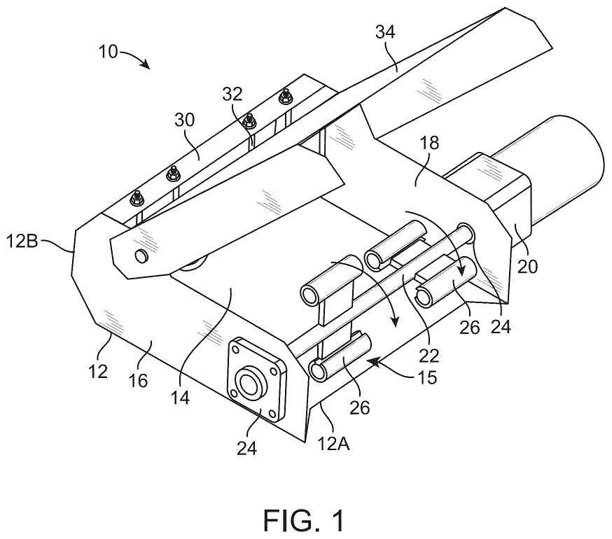

Various features and embodiments of a mat are explained in conjunction with the description of FIGS. (FIGS. 1-5.

FIG. 1 is a perspective view of head extension for surface treatment operations 10 (hereinafter referred to as head extension 10), in accordance with one exemplary embodiment of the present subject matter. Head extension 10 includes housing 12. Housing 12 has first operative end 12A and second operative end 12B. Housing 12 is open at both operative ends 12A and 12B. Further, housing 12 includes base 14 and pair of sidewalls 16, 18 extending substantially vertically from lateral ends of base 14.

Alternative embodiments of head extension 10 could include variations in the configuration of housing 12. In one alternative embodiment, housing 12 may be constructed from different materials to suit specific environmental conditions or operational requirements, such as high-temperature resistance or corrosion resistance. In another embodiment, sidewalls 16, 18 may include additional reinforcement or insulation, depending on the nature of the surface treatment being performed.

Referring back to FIG. 1, adjacent first operative end 12A, housing 12 includes cam assembly 15. Cam assembly 15 comprises motor 20 affixed to housing 12 on exterior surface of sidewall 18. Cam assembly 15 further includes shaft 22 supported on mount bearings 24 and coupled to motor 20. Cam assembly 15 further includes a plurality of cams 26 provided on shaft 22 and configured thereon in a spaced apart manner.

In another embodiment, cam assembly 15 may be designed with different motors, such as a stepper motor or a servo motor, depending on the precision and control needed for specific applications. In another embodiment, the placement of motor 20 may be varied, with motor 20 positioned inside housing 12 for protection in environments where exposure to dust or moisture might be a concern.

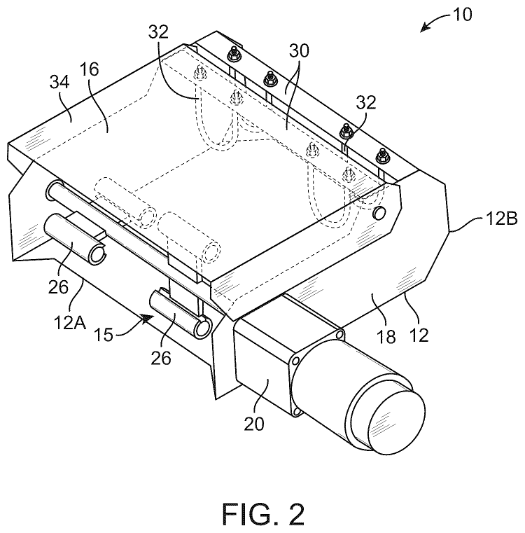

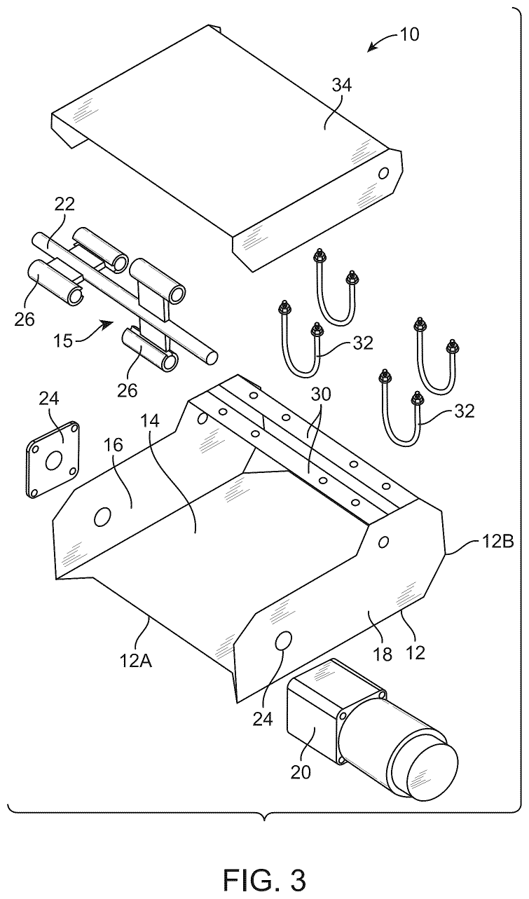

FIG. 2 is another perspective view of head extension 10, in accordance with one exemplary embodiment of the present subject matter. FIG. 3 is an exploded view of head extension for surface treatment operations, in accordance with one exemplary embodiment of the present subject matter. Referring to FIG. 2 and FIG. 3, head extension 10 includes holder assembly 28 configured adjacent second operative end 12B. Holder assembly 28 includes a plurality of support plates 30 positioned across a width of housing 12 and supported on pair of sidewalls 16, 18 adjacent second operative end 12B. In one embodiment, plurality of support plates 30 are positioned in a spaced apart manner and affixed to pair of sidewalls 16, 18.

In one embodiment, plurality of support plates 30 may be integrally connected to pair of sidewalls 16, 18. More specifically, integral connection means that support plates 30 and sidewalls 16, 18 are fabricated as a single continuous unit. In another embodiment, plurality of support plates 30 may be removably connected to pair of sidewalls 16, 18 by means of press fit or snap fit arrangements configured thereon. In a press fit arrangement, support plates 30 are inserted into pre-designed slots or recesses on sidewalls 16, 18, where they are held in place by friction. In a snap fit arrangement, support plates 30 are secured by clips, latches, or other fastening mechanisms that engage corresponding features on sidewalls 16, 18. The removability of support plates 30 allows for easy replacement, reconfiguration, or cleaning, making this embodiment suitable for operations requiring frequent adjustments or maintenance.

As seen in FIG. 2 and FIG. 3, each support plate 30 further includes at least one support loop 32 provided on the support plate 30. In one embodiment, support loops 32 may be assembled onto support plates 30 such that support loops 32 extend into an interior space of housing 12, where such interior space is defined by pair of sidewalls 16, 18 and lid 34. In one embodiment, support loops 32 may be made integral to support plates 30. Lid 34 is pivotally coupled to pair of sidewalls 16, 18 such that pair of sidewalls 16, 18 and lid 34 define the interior space for housing 12.

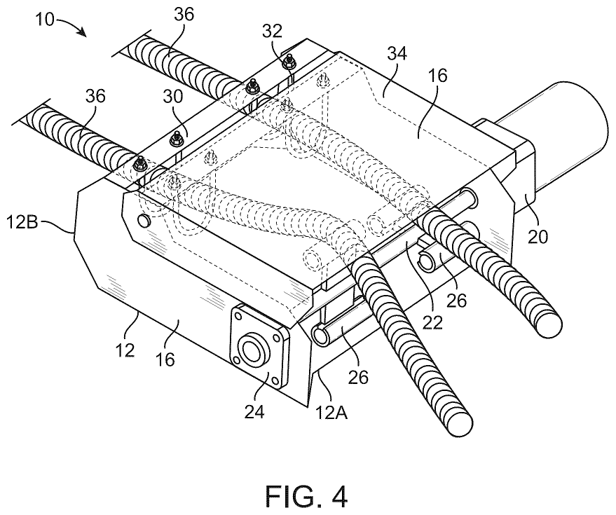

FIG. 4 is yet another perspective view of head extension 10 for surface treatment operations depicting hoses 36 used in sand blasting operation, in accordance with one exemplary embodiment of the present subject matter. One exemplary application of head extension 10 is in sandblasting application. As seen in FIG. 4, hoses 36 are connected to sand blasting equipment (not shown in FIG. 4). It is to be noted that sand blasting is just one exemplary application of head extension 10. Head extension 10 may be used in any surface treatment operation that involves providing reciprocating movement to dispensing means associated with the surface treatment operation. Examples of such surface treatment operations include painting, sand blasting, pressure washing, and the like.

As seen in FIG. 4, hoses 36 enter into housing 12 via second operative end 12B and through support loops 32. In one embodiment, support loops 32 are aligned with cams 26 such that hoses 36 entering into housing 12 through second operative end 12B may interact with cams 26. More specifically, ends of hoses 36 are supported on cams 26 such that hoses 36 are in abutment with cams 26. Motor 20 provides a rotational drive to shaft 22, which in turn facilitates rotation of cams 26. As cams 26 rotate, such rotation facilitates a linear reciprocating movement of hoses 36 supported thereon. As mentioned previously, hoses 36 are hoses attached to sand blasting equipment, and such automated linear reciprocating movement of hoses 36 eliminates the need of having a human operator moving dispensing hoses manually.

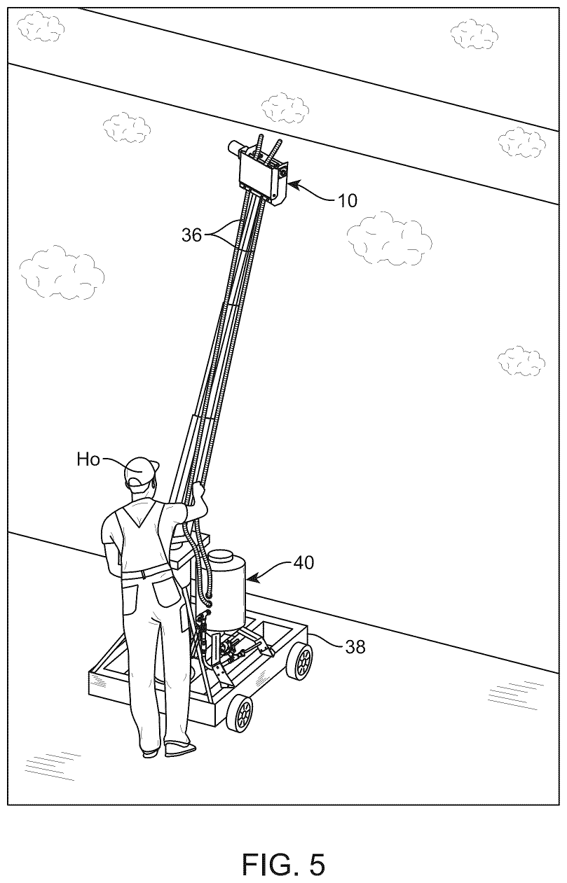

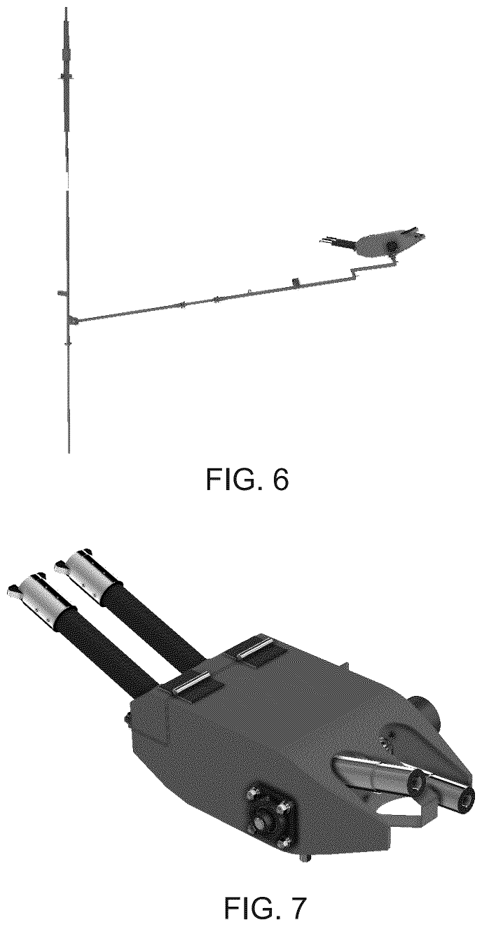

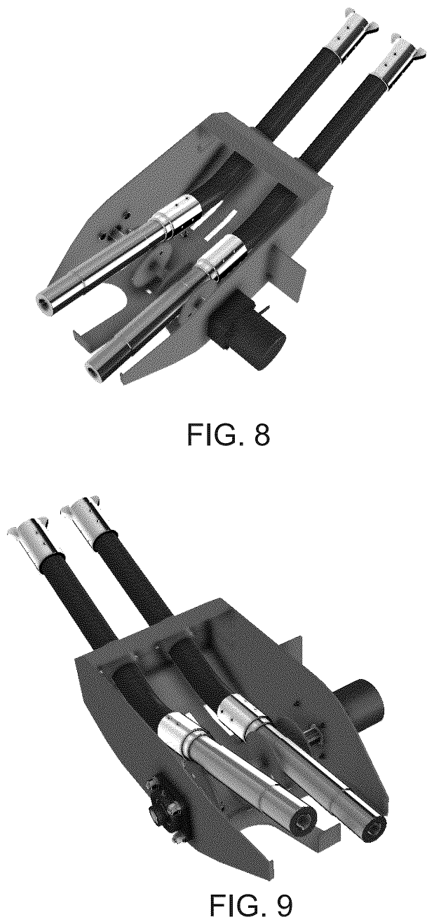

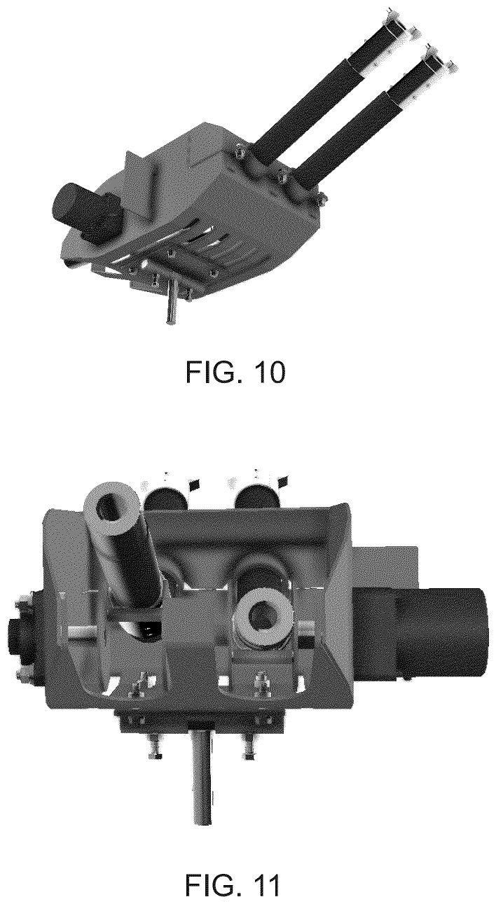

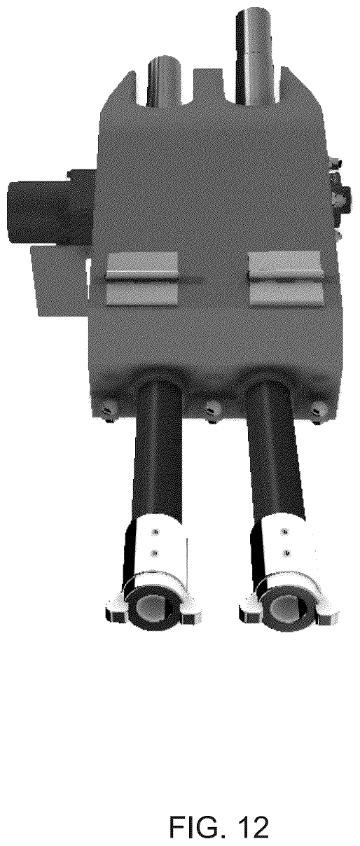

FIG. 5 is an environment in which head extension for surface treatment operations implements, in accordance with one exemplary embodiment of the present subject matter. FIG. 5 displays the practicality of head extension 10. As seen in FIG. 5, human operator HO can use head extension 10 to perform surface treatment operations on surfaces located at heights. More specifically, head extension 10 can be installed to portable crane 38, wherein portable crane 38 can be used to reach high locations otherwise inaccessible to human operator HO without the use of ladders or lifts. Using head extension 10 and portable crane 38, human operator HO can reach high inaccessible locations while being safely positioned on ground.

Alternative embodiments of the invention may include head extension 10 being attached to other types of lifting equipment, such as aerial work platforms, scissor lifts, or telescopic booms. These alternative configurations would provide similar benefits by enabling the human operator to reach elevated surfaces while maintaining a safe position on the ground. The choice of lifting equipment may vary depending on factors such as the specific requirements of the surface treatment operation, the height and accessibility of the surface, and the working environment. It is important to note that while the description focuses on using head extension 10 with portable crane 38, other configurations are also within the scope of the invention. The specific type of lifting equipment should not be construed as a limitation on the invention's applicability.

As seen in FIG. 5, a sand blasting setup is depicted. Sand blasting equipment 40 is provided on portable crane 38, and hoses 36 from sand blasting setup extend into head extension 10. Referring back to FIG. 4, hoses 36 enter into housing 12 of head extension 10 via second operative end 12B, which has an open configuration. Once hoses 36 enter into housing 12, they are routed through support loops 32 towards plurality of cams 26. As shown in FIG. 4, dispensing ends of hoses 36 are in abutment with or supported on plurality of cams 26 such that rotation of plurality of cams 26 facilitates linear reciprocating movement of hoses 36.

In an alternative embodiment, hoses 36 could be utilized for different surface treatment techniques, such as water jetting, chemical spraying, or abrasive blasting with different media types. The versatility of head extension 10 allows for adaptability to various surface treatment needs, depending on the specific application and requirements of the treated surfaces. It should be understood that design of head extension 10 accommodates various types of hoses and treatment media, and the description should not be seen as limiting the invention to sand blasting only.

As can be understood from FIG. 5, the linear reciprocating movement of hoses 36 facilitates performance of sand blasting operation of walls at high locations. The linear reciprocating movement of hoses 36 ensures that maximum surface area of wall is treated through minimal movement of head extension 10, thereby reducing physical efforts required by human operator HO to continuously maneuver head extension 10.

In an alternative embodiment, head extension 10 could incorporate automated control systems to further reduce the need for manual intervention by human operator HO. Sensors and actuators could be integrated to detect the position of head extension 10 and automatically adjust the movement of hoses 36 based on the surface being treated. Such enhancements would further improve the efficiency and safety of the surface treatment process, particularly in hazardous or difficult-to-reach environments. It is also possible to include remote control capabilities, allowing operator HO to control head extension 10 and crane 38 from a distance, further enhancing safety.

Head extension 10 for surface treatment operations offers several advantageous aspects that enhance both the efficiency and safety of surface treatment processes, particularly when treating elevated or hard-to-reach surfaces. Head extension 10, when mounted on portable crane 38 or similar lifting equipment, enables human operator HO to perform surface treatment tasks from ground level, thereby reducing the risk associated with working at heights and minimizing the potential for accidents or falls. By providing a stable platform for hoses 36, head extension 10 allows for precise control over the delivery of surface treatment media, such as abrasives in sand blasting, ensuring that the treatment is applied evenly and effectively across the target surface.

Another advantageous aspect provided by head extension 10 is its ability to facilitate linear reciprocating movement of hoses 36 through interaction with cams 26. The movement pattern allows for extensive coverage of the surface area with minimal repositioning of head extension 10, thereby reducing the physical effort required by human operator HO and minimizing downtime associated with repositioning equipment.

Head extension 10 is also versatile in its application. More specifically, head extension 10 can be adapted for use with various types of surface treatment media and methods, including water jetting, chemical spraying, or abrasive blasting with different media types, depending on the requirements of the operation. Such adaptability ensures that head extension 10 can be utilized across a wide range of industrial applications, providing flexibility and enhancing its value as a multi-purpose tool.

A person skilled in the art appreciates that the mat can come in a variety of shapes and sizes depending on the need and comfort of the user. Further, many changes in the design and placement of components may take place without deviating from the scope of the presently disclosed mat.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. I claim all of the above subject matter.
